(19) United States
(12) Patent Application Publication
(10) Pub. No.: US 2025/0300208 A1
(43) Pub. Date: Sep. 25, 2025

(54) METHOD FOR REMAINING BELOW A LOWER HYDROGEN EXPLOSION LIMIT IN AN EXHAUST OF A FUEL CELL UNIT

(71) Applicant: Robert Bosch GmbH, Stuttgart (DE)

(72) Inventor: Helerson Kemmer, Vaihingen (DE)

(21) Appl. No.: 18/860,740

(22) PCT Filed: Apr. 20, 2023
(86) PCT No.: PCT/EP2023/060275

§ 371 Date: Oct. 28, 2024

(30) Foreign Application Priority Data
Apr. 28, 2022 (DE) 10 2022 204 149.6

(51) Int. Cl. H01M 8/04791; H01M 8/04302; H01M 8/0444; H01M 8/04746; H01M 8/04992

(52) U.S. Cl. CPC H01M 8/04805; H01M 8/04302; H01M 8/0447; H01M 8/04753; H01M 8/04992; H01M 2250/20

(57) ABSTRACT

The invention relates to a method for preventing an automatically continued ignition of hydrogen in an exhaust (150) of a fuel cell unit, in particular of a fuel cell vehicle, when the fuel cell unit is started, characterized in that, when at least one start condition of the fuel cell unit is met, reactive hydrogen is removed from a cathode- side and/or exhaust-side gas of the fuel cell unit until, when the fuel cell unit is started, an actual level of a hydrogen concentration in the exhaust (150) is below the lower hydrogen explosion limit, and the method is preferably carried out only when an initial level of the hydrogen concentration of the cathode-side and/or exhaust-side gas in the fuel cell unit is above the lower hydrogen explosion limit for the exhaust (150).

### BACKGROUND

The invention relates to a method for preventing an automatically continued ignition of hydrogen in an exhaust of a fuel cell unit, in particular of a fuel cell vehicle. Furthermore, the invention relates to a fuel cell unit, a fuel cell system, or a fuel cell vehicle.

In a low-temperature polymer electrolyte fuel cell of a fuel cell unit (stationary or mobile), e.g. of a fuel cell system of a fuel cell vehicle, an electrochemical conversion of two reactants of two operating media into electrical energy and heat takes place. The fuel cell in this case comprises at least one membrane electrode assembly (MEA). As a rule, the fuel cell is designed to comprise a plurality of membrane electrode assemblies arranged in a stack and bipolar plates arranged between them (fuel cell stack).

An integrity of the catalyst layers of the membrane electrode assemblies is critical for a performance characteristic and a service life of the fuel cell stack. Thus, when shutting down the fuel cell unit, the fuel cell stack is blocked on the cathode side and anode side in order to delay, whenever possible, the preconditions for an air/air start of the fuel cell unit that damages the catalyst layers of the cathode of the fuel cell stack. If conditions exist for an air/air start, appropriate countermeasures should be taken prior to starting the fuel cell unit.

Before conditions for an air/air start are present, nitrogen from the cathode diffuses into the anode and hydrogen diffuses into the cathode of the fuel cell stack. When the fuel cell unit is started, hydrogen in the cathode can lead to an increased concentration of hydrogen in an exhaust of the fuel cell unit, as a result of which compliance with the lower explosive limit (LEL) is not always guaranteed. The invention thus addresses the problem of keeping a hydrogen concentration in an exhaust of a fuel cell unit low, so that there is no automatically continued ignition of the hydrogen in the exhaust, i.e. after ignition of hydrogen, a flame in the exhaust that is independent of the ignition source cannot continue.

### SUMMARY

The problem addressed by the invention is solved by a method for preventing the automatically continued ignition of hydrogen in an exhaust of a fuel cell unit, in particular of a fuel cell vehicle, when the fuel cell unit is started; as well as by means of a fuel cell unit, a fuel cell system, or a fuel cell vehicle. Advantageous further developments, additional features and/or advantages of the invention are apparent from the dependent claims and the following description.

In the method according to the invention, when at least one start condition of the fuel cell unit is met, reactive hydrogen is removed from a cathode-side and/or exhaust-side gas of the fuel cell unit until, when the fuel cell unit is started, an actual level of a hydrogen concentration in the exhaust is below the lower hydrogen explosion limit, wherein the method is preferably carried out only when an initial level of the hydrogen concentration of the cathode-side and/or exhaust-side gas in the fuel cell unit is above the lower hydrogen explosion limit for the exhaust.

That is to say, according to the invention, prior to actual commissioning of the fuel cell stack of the fuel cell unit, a hydrogen concentration in the cathode-side and/or exhaust-side gas for the exhaust of the fuel cell unit is reduced such that the lower hydrogen explosion limit of the gas is at least fallen below of in the exhaust. Of course, this can also refer to the cathode. In the cathode, the problem of explosion of the hydrogen is less pronounced, so that a focus of the invention lies on the exhaust.

The term “cathode-side and/or exhaust-side” is intended to mean that the issue is hydrogen in particular from the cathode of the fuel cell stack of the fuel cell unit, wherein the hydrogen is diffused from the anode of the fuel cell stack into the cathode. It is irrelevant whether the hydrogen was, or is now, in a cathode supply path, in the cathode chambers of the fuel cell stack, in a cathode exhaust path, in a wastegate or bypass of the cathode supply downstream thereof, in an anode exhaust path of an anode supply (purge line or the like), and/or in the exhaust. What is important is that, when the fuel cell stack is actually put into service, the hydrogen concentration in the exhaust is below the lower hydrogen explosion limit.

The removal of reactive hydrogen from the cathode-side and/or exhaust-side gas can be accomplished by oxygen, preferably by contacting the cathode-side and/or exhaust-side gas with air. Air can diffuse into the cathode-side and/or exhaust-side gas, air can be conveyed into the cathode-side and/or exhaust-side gas, and/or air can be conveyed into the cathode-side and/or exhaust-side gas. That is to say, the reactive hydrogen in the cathode-side and/or exhaust-side gas reacts with oxygen, in particular with aerated oxygen. In chronological sequence, the fuel cell unit can be started and the fuel cell stack can be operated. A hydrogen concentration peak in the exhaust is effectively prevented.

Chronologically prior to the presence of the at least one start condition, fluid communication of the cathode with the surroundings is and/or becomes prevented. Leakage can occur here (one of the causes of a possible later air/air start of the fuel cell unit). In this case, both cathode check valves can be and/or become closed. Here too, leakage can occur, in particular due to the check valves (i.e. one of the causes of a later possible air/air start). Furthermore, the anode of the fuel cell unit is and/or becomes blocked.

The at least one start condition of the fuel cell unit can be characterized by a signal of an intended start or by a start of the fuel cell unit. Furthermore, the start condition can be characterized by a pre-specified or predetermined date, and/or is determined by an AI-based model. Moreover, the start condition can be characterized by an internal signal originating from a fuel cell system of the fuel cell unit. Furthermore, the start condition can be characterized by an external signal originating from beyond the/a fuel cell system of the fuel cell unit. In this case, the fuel cell unit is of course associated with the fuel cell system.

The initial level of hydrogen concentration in the cathode-side and/or exhaust-side gas can be estimated, determined, and/or measured. Here, for example, the initial level can preferably be estimated on the basis of a downtime of the fuel cell unit. The initial level of the hydrogen concentration can further be determined by a previously known characteristic curve or a previously known characteristic map and/or an AI-based model. Moreover, the initial level can be measured or determined by a cathode-side sensor, in particular a hydrogen sensor. Furthermore, the initial height can be determined by an anode-side sensor, in particular a hydrogen sensor, as needed.

Based on the initial level of hydrogen concentration in the cathode-side and/or exhaust-side gas, it can then of course be decided whether or not the hydrogen concentration is above the lower hydrogen explosion limit for the exhaust. If the former is the case, the method is continued; if the latter is the case, then the method can be suspended, and the startup of the fuel cell unit can be continued

For the removal of reactive hydrogen from the cathode-side and/or exhaust-side gas, a fluid conveying device of a cathode supply of the fuel cell unit can be started and operated. Here, a wastegate of the cathode supply or a cathode-side bypass of the fuel cell stack can be opened and remain open, or it can remain closed. Here, a cathode inlet check valve can be opened, and a cathode outlet check valve of the cathode supply can remain closed. In particular, the wastegate or the cathode-side bypass remains closed. Alternatively, a cathode outlet check valve can be opened, and a cathode inlet check valve of the cathode supply can remain closed. In particular, the wastegate or the cathode-side bypass is opened.

For example, the fluid conveying device of the cathode supply can initially be started and, in chronological sequence, the one cathode check valve can be opened. Alternatively, the one cathode check valve can be first opened and, in chronological sequence, the fluid conveying device of the cathode supply can be started. Alternatively, the fluid conveying device of the cathode supply can be started and the one cathode check valve can be opened substantially at the same time. The wastegate or cathode-side bypass must be opened (cathode outlet check valve open) or closed (cathode inlet check valve open) accordingly.

For the removal of reactive hydrogen from the cathode-side and/or exhaust-side gas, the cathode can be exposed to or filled with air at least once at the inlet side and once on the outlet side, or alternatively, even at a higher frequency (greater than 0.5 Hz), on the inlet and outlet side. For example, the fluid conveying device of the cathode supply is started and the cathode inlet check valve is opened, wherein the cathode outlet check valve on the one hand and the wastegate of the cathode supply or cathode-side bypass remains closed on the other hand. Air is forced or conveyed into the cathode on the inlet side. Now, the cathode inlet check valve is closed, wherein the fluid conveying means continues to be operated at lower power, or can even be turned off, if necessary.

In the chronological sequence, on the one hand, the cathode outlet check valve and, on the other hand, the waste gate of the cathode supply or the cathode-side bypass is opened. Valves that do not lead to the cathode on the outlet side must or can be likewise closed, so that air can be forced or conveyed into the cathode on the outlet side. Furthermore, the fluid conveying device again acts analogously to the inlet-side supply of the cathode with air. Air is now conveyed or forced into the cathode on the outlet side. Now, in the chronological sequence, the cathode can again be supplied with air on the inlet side, etc. The frequency that is well or best suitable for removing reactive hydrogen from the cathode-side and/or exhaust-side gas can be determined experimentally.

Upon removal of reactive hydrogen, the actual level of hydrogen concentration in the cathode-side and/or exhaust-side gas can be estimated, determined, and/or measured. For example, the actual level of hydrogen concentration can be estimated on the basis of a previous downtime of the fuel cell unit. Furthermore, the actual height can be determined by a previously known characteristic curve or a previously known characteristic map and/or an AI-based model. Moreover, the actual level of hydrogen concentration in the cathode-side and/or exhaust-side gas can be measured or determined by a cathode-side or exhaust-side sensor, in particular a hydrogen sensor.

If, for example, the estimated, determined, and/or measured actual level of hydrogen concentration in the cathode-side and/or exhaust-side gas is below the lower hydrogen explosion limit, then the still closed cathode check valve, in particular the cathode outlet check valve or the cathode inlet check valve, is opened and the startup of the fuel cell unit can be continued. The entire method can be carried out e.g. on the basis of an internal signal originating from the fuel cell unit. Furthermore, the entire method can be carried out on the basis of an external signal originating from beyond the fuel cell unit. Moreover, the entire method can be carried out at substantially any start-up of the fuel cell unit.

The invention can be proven simply by observing a cathode-side fluid pressure or fluid mass flow during startup of the fuel cell unit, in particular during a filling of the cathode with fresh air. The observation of the sequence and a chronological course of the actuation of the check valves is also possible with regard to proof of the invention.

### BRIEF DESCRIPTION OF THE DRAWINGS

The invention is explained in further detail hereinafter by way of the attached schematic drawings, which are not to scale, with reference to exemplary embodiments. In the invention, a feature can be positive, i.e. present, or negative, i.e. absent. In the present specification, a negative feature is not explicitly explained as a feature unless it is described as being absent according to the invention. In other words, what is actually achieved-and not an invention construed via the prior art-consists of omitting this feature. The absence of a feature (negative feature) in an exemplary embodiment demonstrates that the feature is optional. The figures (FIG.) in the drawing, which are merely examples, show:

FIG. 1 a simplified block diagram of an embodiment of a fuel cell unit for a fuel cell system of a fuel cell vehicle,

FIG. 2 a simplified block diagram of an embodiment of a cathode supply of the fuel cell unit that represents an alternative to FIG. 1, and

FIG. 3 a possible flow diagram for a method according to the invention for preventing an automatic ignition of hydrogen in an exhaust of the fuel cell unit.

### DETAILED DESCRIPTION

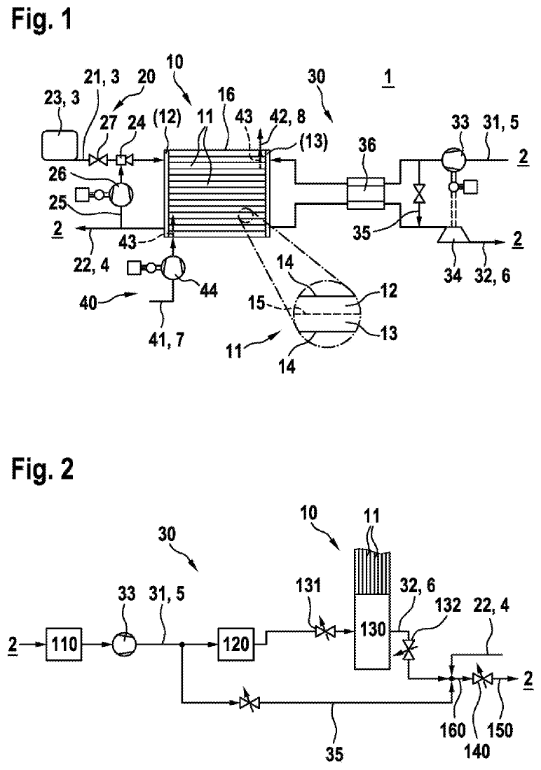

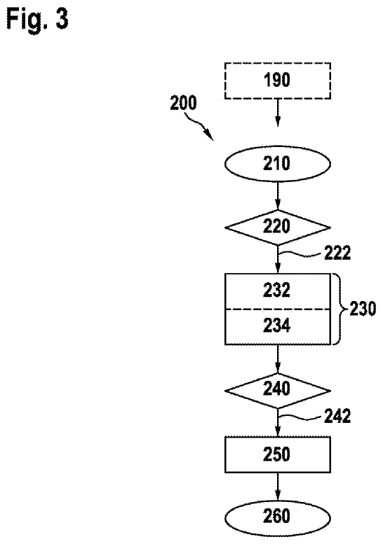

The invention is explained in further detail with the aid of a method 200 (cf. FIG. 3) for remaining below a lower hydrogen limit in an exhaust 150 of a fuel cell unit 1 (cf. FIGS. 1 and 2), i.e. with the aid of a method 200 (cf. FIG. 3) for preventing an automatic ignition of hydrogen in the exhaust 150 of the fuel cell unit 1 for a low temperature polymer electrolyte fuel cell system of a fuel cell vehicle, i.e. a motor vehicle comprising a fuel cell or a fuel cell system.

Only those portions (FIG. 1: full cell unit 1) of the fuel cell system that are necessary for an understanding of the invention are shown in the drawings. Although the invention is described and illustrated in more detail by way of preferred embodiments, the invention is not limited by the exemplary embodiments disclosed. Other variations can be derived therefrom without departing from the protective scope of the invention.

FIG. 1 shows the fuel cell unit 1 according to one embodiment, comprising at least one, in particular a plurality, of single electrochemical fuel cells 11, 11, . . . (single cells 11, 11, . . . ) bundled together to form a fuel cell stack 10, which are housed in a preferably fluid-tight stack housing 16. Each single cell 11 comprises an electrode chamber 12 designed as an anode chamber 12, preferably with a gas diffusion layer (optionally including a microporous particle layer), and an electrode chamber 13 designed as a cathode chamber 13, preferably with a gas diffusion layer (optionally including a microporous particle layer), which are spatially and electrically separated from each other by a membrane-electrode assembly 15. The gas diffusion layers are preferably associated with the membrane-electrode assembly 15.

Arranged in each case between two directly adjacent membrane-electrode assemblies 15, 15 (including a respective anode chamber 12 and a cathode chamber 13) is a bipolar plate 14 (separator board assembly, preferably consisting of an anode board (electrode board) and a cathode board (electrode board)), which is used, among other things, to feed/discharge operating media 3, 5 into an anode chamber 12 of a first single cell 11 and a cathode chamber 13 of a second single cell 11 directly adjacent thereto and, in addition, to achieve an electrically conductive connection between these single cells 11, 11.

The fuel cell unit 1 comprises an anode supply 20 and a cathode supply 30 for supplying the fuel cell stack 10 with its actual operating media 3 (anode operating medium, actual fuel), 5 (cathode operating medium, usually air). The anode supply 20 comprises in particular: a fuel reservoir 23 for the anode operating media 3 (flowing in); an anode supply path 21 having a shut-off/metering valve 27 and an ejector 24; an anode exhaust path 22 for an anode exhaust gas medium 4 (flowing out, usually into the surroundings 2); preferably a fuel recirculation line 25 with a fluid conveying device 26 located therein, and optionally a water separator and optionally a water container.

The cathode supply 30 comprises in particular: a cathode supply path 31 for the cathode operating medium 5 (flowing in, usually from the surroundings 2), preferably with a fluid conveying device 33; a cathode gas path 32 for a cathode exhaust gas medium 6 (flowing out, usually into the surroundings 2) preferably with a turbine 34, in particular for the fluid conveying device 33; preferably a moisture transfer device 36; optionally a waste gate 35 between the cathode supply path 31 and the cathode exhaust gas path 22; and optionally a water separator and optionally a water container.

The fuel cell unit 1 also comprises, in particular, a cooling medium supply 40 of a thermal system, in particular of the fuel cell vehicle, through which the fuel cell can be integrated into a cooling circuit for temperature adjustment in a heat-transferring manner, preferably by means of its bipolar plates 100 (cooling medium paths 43). The cooling medium supply 40 comprises a cooling medium inlet path 41 and a cooling medium outlet path 42. The cooling medium 7 (flowing in), 8 (flowing out) circulating in the cooling medium supply 40 is preferably conveyed by means of at least one cooling medium conveying device 44. In addition to the fuel cell unit 1, the fuel cell system comprises peripheral system components, e.g. a control device, which can belong to the fuel cell vehicle itself.

FIG. 2 shows an alternative cathode supply 30 of the fuel cell stack 10. Here, a positive or negative feature of FIG. 1 can be applied in FIG. 2, and vice versa. Compared to FIG. 1, the cathode supply 30 of FIG. 2 further shows an air filter 110 upstream of the fluid conveying device 33 and a heat exchanger 120 downstream of the fluid conveying device 33, wherein the heat exchanger 120 can be integrated in particular into the thermal system. Furthermore, FIG. 2 shows a ‘cathode 130’ of the fuel cell stack 10 which, when the fuel cell unit 1 is shut off (see below), can be blocked by a cathode inlet check valve 131 in the cathode supply path 31 and a cathode outlet check valve 132 in the cathode exhaust path 32. The cathode exhaust path 32 opens downstream, e.g. in an exhaust line 160 of the fuel cell unit 1.

The actual cathode 130 of the fuel cell stack 10 is configured in particular in the cathode chambers 13, 13, . . . of the single cells 11, 11, . . . . A cathode-side gas is located in the cathode 130, i.e. actually in the cathode chambers 13, 13, . . . of the single cells 11, 11, . . . , in at least one cathode supply channel of the cathode operating medium 5 on and in the fuel cell stack 10, as well as in at least one cathode discharge channel of the cathode exhaust gas medium 6 on and in fuel cell stack 10. During a downtime of the fuel cell unit 1, the cathode-side gas of the fuel cell unit 1 can be trapped there between the closed cathode inlet check valve 131 and the closed cathode outlet check valve 132.

Upon a start of the fuel cell unit 1, this cathode-side gas mixes with an exhaust side gas of the fuel cell unit 1 located downstream in an exhaust 150 of the fuel cell unit 1. The exhaust line 160 opens downstream in the exhaust 150. A cathode-side and exhaust-side gas is generated, which may have a hydrogen concentration above the lower hydrogen explosion limit in the exhaust 150. Furthermore, in particular, a pressure regulator 140 of the fuel cell unit 1 is positioned upstream of the exhaust 150 on/in the exhaust line 160.

A shutdown process for a fuel cell unit 1, in particular in the vehicle field, typically comprises the following steps. First: Blowing dry the un-powered cathode 130 (i.e. the individual cathodes in the cathode chambers 13, 13, . . . ) of the fuel cell stack 10. Second: Closing the check valves 131, 132 of the cathode 130. Third: Oxygen reduction (bleed-down) of the cathode 130 by applying a low load, thereby resulting in a low oxygen partial pressure on the cathode 130. Fourth: Closing the check valves of the anode (single anodes in anode chambers 12, 12, . . . ). As a result, the fuel cell stack 10 is placed in a state with nitrogen on the cathode and hydrogen on the anode, respectively moistened, and on the anode with residues of nitrogen.

Thus, when the fuel cell unit 1 is stopped, a cathode-side gas is trapped in by way of cathode check valves 131, 132 on and in the fuel cell stack 10. This serves to ensure that no oxygen or air penetrates the cathode 130 in order to prevent degrading electrochemical potentials upon a subsequent re-start of the fuel cell unit 1. In particular, as a result, so-called air/air starts of the fuel cell unit 1 that damage the cathode 130 are to be prevented.

Over time, hydrogen diffuses from the anode via membrane electrode units 15, 15, . . . to the cathode 130 and remains trapped within the cathode 130. At a subsequent start of the fuel cell unit 1, this hydrogen is purged through the air flow. This can result in increased levels of hydrogen in the exhaust 150. Compliance with the lower explosion limit is not always guaranteed. One embodiment of the invention is described below for how too high a hydrogen concentration in the cathode 130 and thus also too high a hydrogen concentration at a start of the fuel cell unit 1 in the exhaust 150 can be countered. This is illustrated by way of example in the flow diagram of FIG. 3. Of course, the invention is not limited to this (cf. above).

Prior to performing the method, the cathode 130 is blocked, in particular the two cathode check valves 131, 132 were or are closed. Furthermore, preferably the anode is also preferably blocked by means of check valves. This is clarified in FIG. 3 with reference numeral 190. If there is now at least one start condition of the fuel cell unit 1 (e.g. first step 210 of the method 200), then the method 200 for preventing an automatically continued ignition of hydrogen in the exhaust 150 of the fuel cell unit 1 can be started. In this case, it is determined whether at least one start condition (cf. above) of the fuel cell unit 1 is present 210.

If at least one start condition is present 210, then it can be queried 220 (e.g. estimated, determined, and/or measured) in chronological order (e.g. second step 220 of method 200 (optionally)) as to whether an initial level of hydrogen concentration of the cathode-side and/or exhaust-side gas is above the lower hydrogen explosion limit for and/or in the exhaust 150 (cf. above). If this is the case (222: yes), then the method 200 is continued; if this is not the case, then the method 200 can be discontinued and the start of the fuel cell unit 1 can be continued (not shown in FIG. 3).

Now (e.g. third step 230 of the method 200), reactive hydrogen can be removed from the cathode-side and/or exhaust-side gas 230 (cf. above). Here, step 230 can comprise at least two sequential (232=>234, 234=>232) or two parallel (232/234) sub-steps 232, 234. The sub-step 232 consists of starting the fluid conveying device 33; or opening the cathode inlet check valve 131, wherein the cathode outlet check valve 132 remains closed, or opening the cathode outlet check valve 132, wherein the cathode inlet check valve 131 then remains closed. The sub-step 234 consists of opening the cathode outlet check valve 132, wherein the cathode inlet check valve 131 remains closed, or opening the cathode inlet check valve 131, wherein the cathode outlet check valve 132 remains closed; or starting the fluid conveying device 33.

Here (e.g. fourth step 240 of the method 200 (optional)), it is possible to query (estimate, determine, and/or measure) whether an actual level of hydrogen concentration for the exhaust 150 is below the lower hydrogen limit 240, or has the cathode-side hydrogen substantially reacted 240 (cf. above)? If this is the case (242: yes), then the method 200 can be concluded; if this is not the case, step 240 will be continued. Alternatively, the removal of reactive hydrogen 230 can simply last for a pre-specified time.

If the level of hydrogen concentration expected or actual for the start of the fuel cell unit 1 for the exhaust 150 is below the lower hydrogen explosion limit (242: yes), then (e.g. fifth step 250 of method 200) the other still closed cathode check valve 132/131, i.e. the cathode outlet check valve 132 and cathode check valve 131, respectively, can be opened. Now the method 200 is ended 260.

Summary. Upon shutting down of a fuel cell unit 1, the cathode-side gas is trapped in by the cathode check valves 131, 132. This serves to ensure that no oxygen or air penetrates the cathode 130 in order to prevent degrading electrochemical potentials upon a subsequent start of the fuel cell unit 1. Over time, hydrogen diffuses from the anode 12, 12 . . . through the membranes to the cathode 130 and remains trapped therein. Upon the start of the fuel cell unit 1, this level of hydrogen is purged by an air flow. This leads to increased hydrogen concentrations in the exhaust 150. Compliance with the lower explosion limit may not be possible there.

To address this, the cathode 130 is provided with fresh oxygen, so that the amount of hydrogen contained therein can react and does not reach the exhaust 150. Upon the start of the fuel cell unit 1, only one of the cathode check valves 131/132 is initially opened for this purpose, until a sufficient level of hydrogen reacts with the oxygen of the air in the cathode 130. This increases safety, because there are no or very low hydrogen emissions at the start. After a certain level of hydrogen has reacted in the cathode 130, the still closed check valve 132/131 of the cathode 130 is opened so that air can flow through the cathode 130. The fuel cell unit 1 can be started and operated normally. A hydrogen concentration peak in the exhaust 150 is safely prevented.

1. A method (200) for preventing an automatically continued ignition of hydrogen in an exhaust (150) of a fuel cell unit (1), when the fuel cell unit (1) is started, wherein,
when at least one start condition (210) of the fuel cell unit (1) is met, reactive hydrogen is removed (230) from a cathode-side and/or exhaust-side gas of the fuel cell unit (1) until, when the fuel cell unit (1) is started, an actual level of a hydrogen concentration in the exhaust (150) is below the lower hydrogen explosion limit (242), wherein
the method (200) is carried out only when an initial level of the hydrogen concentration of the cathode-side and/or exhaust-side gas in the fuel cell unit (1) is above (220) the lower hydrogen explosion limit for the exhaust (150).

2. The method (200) according to claim 1, wherein the removal (230) of reactive hydrogen from the cathode-side and/or exhaust-side gas occurs by oxygen, by a contact of the cathode-side and/or exhaust-side gas with air, wherein air is diffused into the cathode-side and/or exhaust-side gas, and air in is conveyed up to the cathode-side and/or exhaust-side gas, and/or air is conveyed into the cathode-side and/or exhaust-side gas.

3. The method according to claim 1, wherein before (190) the presence of at least one start condition (210):
a fluid communication of the cathode (130) with the surroundings (2) is and/or becomes prevented,
both cathode check valves (131, 132) are and/or become closed, and/or
the anode (12,12, . . . ) of the fuel cell unit (1) is and/or becomes blocked.

4. The method (200) according to claim 1, wherein the at least one start condition (210) of the fuel cell unit (1):
is characterized by a signal of an intended start or a start of the fuel cell unit (1),
is characterized by a pre-specified or previously determined date and/or is determined by an AI-based model,
is characterized by an internal signal originating from a fuel cell system of the fuel cell unit (1), and/or
is characterized by an external signal originating from beyond the/a fuel cell system of the fuel cell unit (1).

5. The method (200) according to claim 1, claims, wherein the initial level of hydrogen concentration in the cathode-side and/or exhaust-side gas is estimated, determined, and/or measured (220), wherein the initial level of hydrogen concentration:
is estimated on the basis of a downtime of the fuel cell unit (1),
is determined by a previously known characteristic curve or a previously known characteristic map and/or an AI-based model,
is measured or determined by a cathode-side a hydrogen sensor, and/or
is determined by an anode-side hydrogen sensor.

6. The method (200) according to claim 1, wherein, for the removal (230) of reactive hydrogen from the cathode-side and/or exhaust-side gas:
a fluid conveying device (33) of a cathode supply (30) of the fuel cell unit (1) is started and operated,
a wastegate (35) of the cathode supply (30) or a cathode-side bypass of the fuel cell stack (10) is opened or remains closed,
a cathode inlet check valve (131) is opened and a cathode outlet check valve (132) of the cathode supply (30) remains closed, and/or
a cathode outlet check valve (132) is opened and a cathode inlet check valve (131) of the cathode supply (30) remains closed.

7. The method (200) according to claim 1, wherein, for the removal (230) of reactive hydrogen from the cathode-side and/or exhaust-side gas, the cathode (130) is exposed or filled with air at least one time on the inlet side and one time on the outlet side, or alternately on the inlet and outlet side.

8. The method (200) according to claim 1, wherein, upon removal of reactive hydrogen (230), the actual level of hydrogen concentration in the cathode-side and/or exhaust-side gas is estimated, determined, and/or measured (240), wherein the actual level of hydrogen concentration:
is estimated on the basis of a previous downtime of the fuel cell unit (1),
is determined by a previously known characteristic curve or a previously known characteristic map and/or an AI-based model, and/or
is measured or determined by a cathode-side or exhaust-side hydrogen sensor.

9. The method (200) according to claim 1, wherein, when the actual level of the hydrogen concentration in the cathode-side and/or exhaust-side gas is below the lower hydrogen explosion limit (242), the still closed cathode check valve (132/131) is opened and the starting of the fuel cell unit (1) is continued.

10. The method (200) according to claim 1, wherein the entire method (200):
is carried out based on an internal signal originating from the fuel cell unit (1),
is carried out based on an external signal originating from beyond the fuel cell unit (1), and/or
is carried out at substantially every start of the fuel cell unit (1).

11. A fuel cell unit (1), a fuel cell system, or a fuel cell vehicle, wherein,
when an initial level of the hydrogen concentration of a cathode-side and/or exhaust-side gas in the fuel cell unit (1) is above (220) a lower hydrogen explosion limit for an exhaust (150) and when at least one start condition (210) of the fuel cell unit (1) is met, reactive hydrogen is removed (230) from the cathode-side and/or exhaust-side gas of the fuel cell unit (1) until, when the fuel cell unit (1) is started, an actual level of a hydrogen concentration in the exhaust (150) is below the lower hydrogen explosion limit (242).
